(19) United States
(12) Patent Application Publication
(10) Pub. No.: US 2009/0191935 A1
(43) Pub. Date: Jul. 30, 2009

(54) GAMING METHOD, GAMING APPARATUS FOR PERFORMING THE GAMING METHOD, AND COMPUTER PROGRAM PRODUCT STORING A GAMING PROGRAM OF THE GAMING METHOD

(76) Inventor: Arden Yang, Rosemead, CA (US)

Correspondence Address: CHRISTIE, PARKER & HALE, LLP, PO BOX 7068, PASADENA, CA, 91109-7068, US

(21) Appl. No.: 12/022,014

(22) Filed: Jan. 29, 2008

(51) Int. Cl. A63F 9/24; G06F 9/44

(52) U.S. Cl. 463/16; 463/20; 717/106

(57) ABSTRACT

A gaming method is implemented using an electronic gaming apparatus, and includes: upon initiating a game, displaying a cell matrix including a plurality of cell groups, each of the cell groups including a plurality of cells, each displaying a randomly selected indicium, the indicia displayed in the cells of the cell groups of the cell matrix forming a pattern; after a bet is placed, randomly selecting one of the cell groups; determining if the displayed indicia in the selected cell group comply with predetermined winning criteria; and if yes, granting an award on the basis of the bet and the predetermined winning criteria. A gaming apparatus and a computer program product are also disclosed.

### BACKGROUND OF THE INVENTION

1. Field of the Invention

The invention relates to a gaming method for a pattern matching game, a gaming apparatus for performing the gaming method, and a computer program product that stores a gaming program of the gaming method.

2. Description of the Related Art

FIG. 1 illustrates a conventional slot machine 1. When playing with the slot machine 1, a player places a bet, and pulls a lever 11 to initiate rotation of a reel unit 12. When the reel unit 12 stops rotating, a pattern of indicia is displayed. An award is then granted to the player on the basis of the bet placed by the player and predetermined winning criteria.

In the following example to illustrate how awards are granted in the slot machine 1, it is assumed that the reel unit 12 displays the pattern shown in FIG. 1 at the end of a game round, and the predetermined winning criteria include the display of the same indicium in at least three adjacent cells of a row 141, 142, 143 of the reel unit 12. Since the same indicium “E” appears in three adjacent cells of the row 141, and the same indicium “A” appears in four adjacent cells of the row 143, corresponding awards are granted on the basis of the bet placed by the player and a preset payout multiplier table.

However, since the probability of obtaining an award by meeting the predetermined winning criteria is usually relatively small, the player simply repeats a series of bet-placing and lever-pulling actions for long periods of time. Hence, the player will easily lose interest and eventually quit playing.

### SUMMARY OF THE INVENTION

Therefore, the object of the present invention is to provide a gaming method in which the player is accorded greater control over the progress and outcome of a pattern matching game so as to overcome the above drawback of the prior art.

According to one aspect of the present invention, there is provided a gaming method to be implemented using an electronic gaming apparatus. The gaming method comprises:

a) in response to operation of the electronic gaming apparatus by a player for initiating a game, displaying a cell matrix including a plurality of cell groups, each of the cell groups including a plurality of cells, each of the cells displaying an indicium selected automatically and randomly by the electronic gaming apparatus from a predetermined set of indicia, the indicia displayed in the cells of the cell groups of the cell matrix forming a pattern;

b) in response to abet placed by the player, randomly selecting one of the cell groups, and notifying the player of the selected one of the cell groups;

c) determining if the indicia displayed in the cells of the selected one of the cell groups comply with predetermined winning criteria; and

d) if it is determined that the indicia displayed in the cells of the selected one of the cell groups comply with the predetermined winning criteria, granting an award to the player on the basis of the bet placed by the player and the predetermined winning criteria to thereby complete a game round.

According to another aspect of the present invention, there is provided a gaming apparatus that comprises: a display unit; a game processing unit coupled to the display unit and configured to perform steps of the gaming method of this invention; and an input unit coupled to the game processing unit and allowing input by a user.

According to yet another aspect of the present invention, there is provided a computer program product comprising a computer-readable storage medium that stores a gaming program for causing an electronic gaming apparatus to execute steps of the gaming method of this invention.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram of a conventional slot machine;

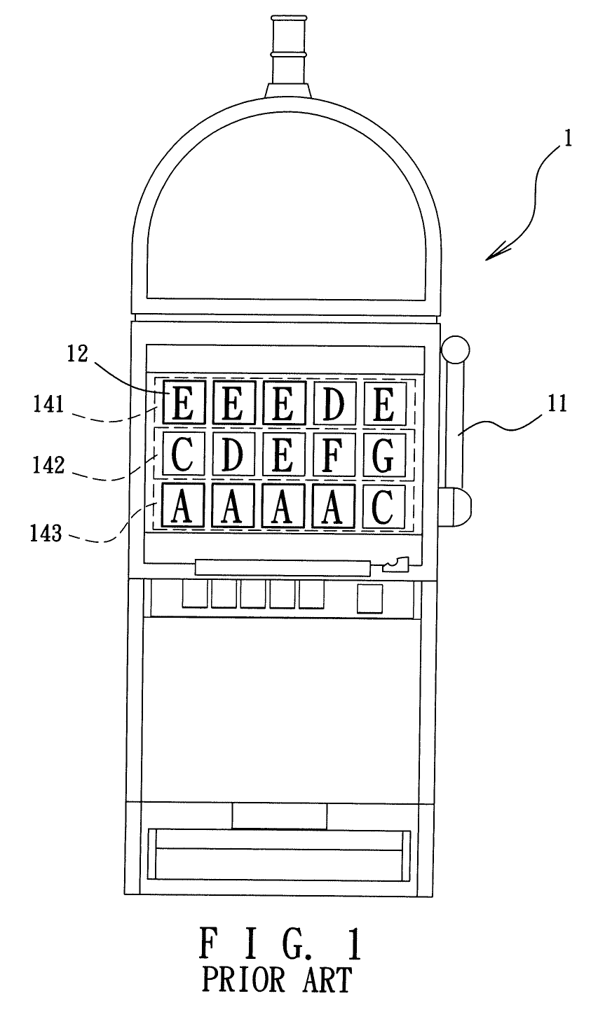

FIG. 2 is a block diagram of the preferred embodiment of a gaming apparatus according to the present invention; and

FIG. 3 is a flowchart to illustrate the preferred embodiment of a gaming method according to the present invention.

### DETAILED DESCRIPTION OF THE PREFERRED EMBODIMENT

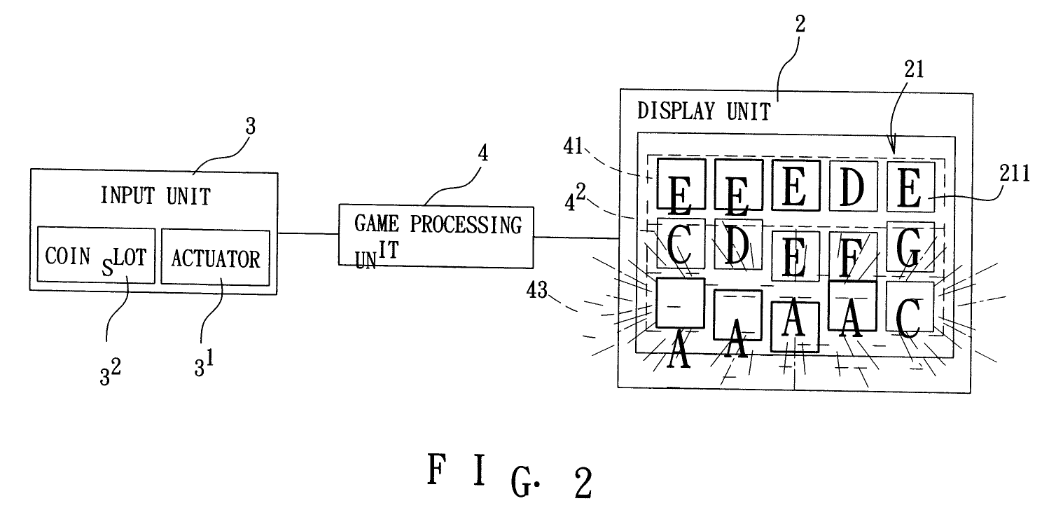

Referring to FIG. 2, an electronic gaming apparatus according to a preferred embodiment of the present invention is shown to comprise a display unit 2, a game processing unit 4 coupled to the display unit 2 and configured to perform steps of a gaming method, and an input unit 3 coupled to the game processing unit 4 and allowing input by a user.

The display unit 2 is for displaying a cell matrix 21 including a plurality of cell groups. Each of the cell groups includes a plurality of cells 211, each displaying an indicium selected automatically and randomly by the game processing unit 4 from a predetermined set of indicia such that the indicia displayed in the cells 211 of the cell groups of the cell matrix 21 form a pattern. In this embodiment, the cell matrix 21 is formed by three rows and five columns of the cells 211, the indicia that can be displayed in the cells 211 include the characters “A”, “B”, “C”, “D”, “E”, “F” and “G”, and the display unit 2 includes a virtual (or computer-generated) reel unit provided with the predetermined set of indicia and displayed undergoing rotation such that the pattern of the cell matrix 21 is formed when the reel unit stops rotating. However, in practice, display of the cell matrix 21 on the display unit 2 should not be limited to the above manner. In other embodiments of the invention, a conventional mechanical reel unit found in commercially available slot machines is utilized for the same purpose.

In this embodiment, the input unit 3 includes an actuator 31 and a coin slot 32. The actuator 31 can be a button or a lever mechanism found in conventional slot machines. The coin slot 32 provides two functions: granting the player a right to operate the actuator 31 after the player deposits an amount of coins or tokens for authority procurement; and permitting the player to place a bet.

The game processing unit 4 is coupled electrically to the display unit 2 and the input unit 3, and includes a computer-readable storage medium (such as a memory component, not shown in the Figures) that stores a gaming program for causing the game processing unit 4 to execute the steps of the gaming method.

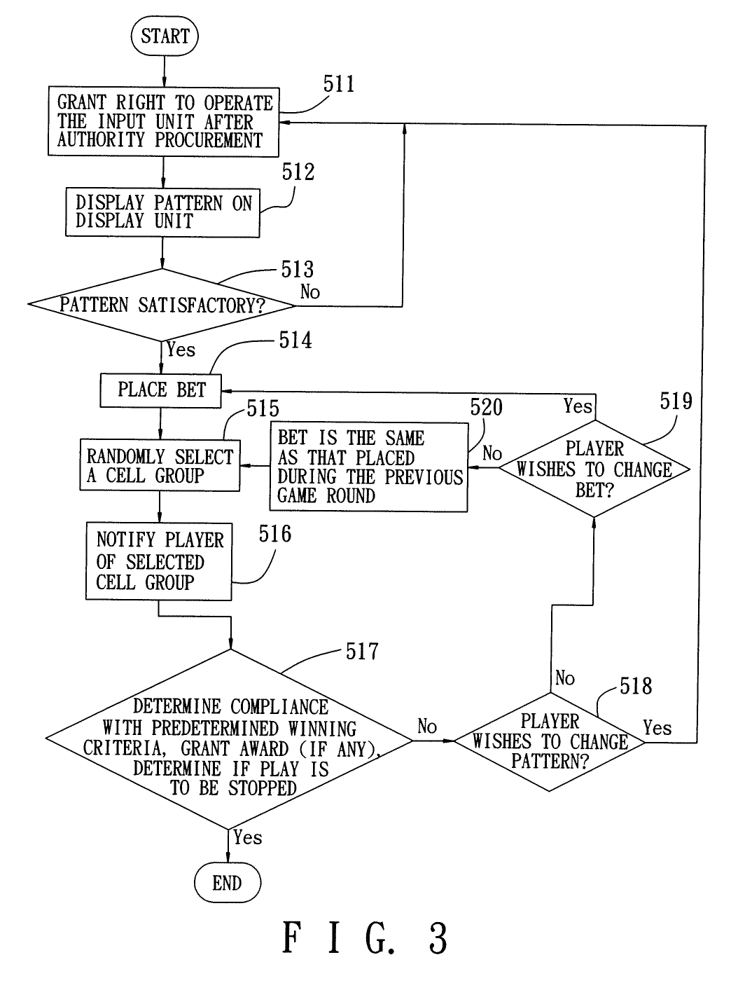

Referring to FIGS. 2 and 3, the gaming method according to a preferred embodiment of this invention includes the following steps:

First, in step 511, the player deposits an amount of coins or tokens through the coin slot 32 of the input unit 3 for authority procurement so as to be granted a right to operate the actuator 31 of the input unit 3 of the electronic gaming apparatus. Thereafter, the player is permitted to operate the actuator 31 for initiating a game and, in response to operation of the actuator 31, the reel unit of the display unit 2 is shown undergoing rotation.

Next, in step 512, the pattern formed from the indicia displayed in the cells 211 of the cell groups of the cell matrix 21 is displayed by the display unit 2 when the reel unit stops rotating. As mentioned hereinabove, the indicium displayed in each of the cells 211 is selected automatically and randomly by the game processing unit 4 from the predetermined set of indicia.

Subsequently, in step 513, the player determines whether the pattern formed by the indicia displayed in the cells 211 of the cell matrix 21 is satisfactory on the basis of predetermined winning criteria. In the preferred embodiment, the predetermined winning criteria include the display of a predetermined number of the same indicium in adjacent ones of the cells 211 of a selected one of the cell groups of the cell matrix 21. In this embodiment, the three cell rows 41, 42 and 43 of the cell matrix 21 serve as the cell groups that are available for selection, and the predetermined winning criteria include the display of the same indicium in at least three adjacent ones of the cells 211 of the selected one of the cell groups. It is noted that, in other embodiments of the invention, the cell groups are not limited to rows of the cell matrix 21. For example, the cell groups may be columns of the cell matrix 21 or blocks of the cell matrix 21, depending on the actual form of the cell matrix 21.

If the player is satisfied with the cell matrix 21, which means that the player believes the probability of being granted an award when playing with the cell matrix 21 to be relatively large on the basis of the predetermined winning criteria, the flow proceeds to step 514, where the player is permitted to place a bet through the coin slot 32 of the input unit 3. On the other hand, if the player is not satisfied with the cell matrix 21, which means that the player believes the probability of being granted an award when playing with the cell matrix 21 to be relatively small on the basis of the predetermined winning criteria, the flow goes back to step 511, where the player deposits another amount of coins or tokens through the coin slot 32 of the input unit 3 for authority procurement so as to be granted a right to operate the actuator 31 of the input unit 3 of the electronic gaming apparatus for displaying another pattern on the display unit 2.

It is noted that the amount of coins or tokens for authority procurement should not be set too high so that the player will not deem it to be too expensive even after the authority procurement operation is repeated for tens of times. The purpose of authority procurement is solely to discourage the player from occupying the electronic gaming apparatus for long periods of time without placing actual bets.

After the player places the bet through the input unit 3, the flow goes to step 515, where the game processing unit 4 randomly selects one of the cell groups in the cell matrix 21. In the following example, it is assumed that the cell row 43 is the cell group selected by the game processing unit 4.

Thereafter, in step 516, the electronic gaming apparatus notifies the player that the cell row 43 is the selected cell group. In this embodiment, the cell row 43 is displayed on the display unit 2 in a flashing manner to notify the player of its selection.

Next, in step 517, the game processing unit 4 determines if the indicia displayed in the cells 211 of the selected cell group comply with the predetermined winning criteria. In the example, since the cell row 43 is the selected cell group and has the same indicium “A” displayed in four adjacent ones of the cells 211 therein, the game processing unit 4 determines in step 517 that the indicia displayed in the cells 211 of the cell row 43 comply with the predetermined winning criteria, and grants an award to the player on the basis of the bet placed by the player and the predetermined winning criteria to thereby complete a game round. At the end of step 517, the player is prompted to determine whether the player wishes to stop playing.

If the player does not wish to stop playing, the flow goes to step 518, where it is determined if the player wishes to change the pattern formed by the indicia displayed in the cells 211 of the cell matrix 21. If it is determined that the player wishes to change the pattern, the flow goes back to step 511 to enable display of another pattern on the display unit 2. On the other hand, if it is determined that the player does not wish change the pattern, which means that the player is still satisfied with the pattern formed by the indicia currently displayed in the cells 211 of the cell matrix 21, the flow goes to step 519.

In step 519, it is determined if the player wishes to change the bet placed thereby before starting another game round. If the player is very satisfied with the current cell matrix 21, the player may opt to increase the bet placed thereby, and the flow goes back to step 514 to allow the player to change the bet placed thereby. If the player does not want to change the bet placed thereby, the flow proceeds to step 520, where the bet of the player is maintained to be the same as that placed during the previous game round, and then goes back to step 515.

In the present invention described hereinabove, the player places the bet only when a satisfactory pattern is displayed on a display unit of the gaming apparatus. Since the player is accorded greater control over the progress and outcome of the game, the interest of the player can be sustained for long periods of time.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A gaming method to be implemented using an electronic gaming apparatus, said gaming method comprising:
a) in response to operation of the electronic gaming apparatus by a player for initiating a game, displaying a cell matrix including a plurality of cell groups, each of the cell groups including a plurality of cells, each of the cells displaying an indicium selected automatically and randomly by the electronic gaming apparatus from a predetermined set of indicia, the indicia displayed in the cells of the cell groups of the cell matrix forming a pattern;
b) in response to abet placed by the player, randomly selecting one of the cell groups, and notifying the player of the selected one of the cell groups;
c) determining if the indicia displayed in the cells of the selected one of the cell groups comply with predetermined winning criteria; and
d) if it is determined that the indicia displayed in the cells of the selected one of the cell groups comply with the predetermined winning criteria, granting an award to the player on the basis of the bet placed by the player and the predetermined winning criteria to thereby complete a game round.

2. The gaming method of claim 1, wherein, in step a), the player is able to operate the electronic gaming apparatus repeatedly until the pattern formed by the indicia displayed in the cells of the cell matrix is found by the player to be satisfactory on the basis of the predetermined winning criteria.

3. The gaming method of claim 1, wherein, in step a), a reel unit provided with the predetermined set of indicia is displayed undergoing rotation such that the pattern is formed when the reel unit stops rotating.

4. The gaming method of claim 1, further comprising, prior to step a), a step (e) of:
in response to authority procurement by the player, granting the player a right to operate the electronic gaming apparatus.

5. The gaming method of claim 1, further comprising, after step d), the steps of:
f-1) determining if the player wishes to change the pattern formed by the indicia displayed in the cells of the cell matrix;
f-2) if it is determined that the player wishes to change the pattern, repeating step a) to display another pattern; and
f-3) if it is determined that the player does not wish to change the pattern, permitting the player to change the bet placed thereby before starting another game round.

6. The gaming method of claim 5, further comprising, after step f-3), the steps of:
g-1) determining if the player wishes to change the bet placed thereby;
g-2) if it is determined that the player wishes to change the bet placed thereby, allowing the player to change the bet placed thereby, and proceeding to step b); and
g-3) if it is determined that the player does not wish to change the bet placed thereby, proceeding directly to step b).

7. The gaming method of claim 1, wherein the predetermined winning criteria include the display of a predetermined number of the same indicium in adjacent ones of the cells of the selected one of the cell groups.

8. A gaming apparatus comprising:
a display unit;
a game processing unit coupled to said display unit and configured to perform steps of a gaming method; and
an input unit coupled to said game processing unit and allowing input by a user;
wherein the gaming method includes:
a) in response to operation of said input unit by a player for initiating a game, displaying on said display unit a cell matrix including a plurality of cell groups, each of the cell groups including a plurality of cells, each of the cells displaying an indicium selected automatically and randomly by said game processing unit from a predetermined set of indicia, the indicia displayed in the cells of the cell groups of the cell matrix forming a pattern;
b) in response to a bet placed by the player through said input unit, randomly selecting one of the cell groups, and notifying the player of the selected one of the cell groups;
c) determining if the indicia displayed in the cells of the selected one of the cell groups comply with predetermined winning criteria; and
d) if it is determined that the indicia displayed in the cells of the selected one of the cell groups comply with the predetermined winning criteria, granting an award to the player on the basis of the bet placed by the player and the predetermined winning criteria to thereby complete a game round.

9. The gaming apparatus of claim 8, wherein said display unit includes a reel unit provided with the predetermined set of indicia.

10. The gaming apparatus of claim 9, wherein, in step a), said reel unit is displayed undergoing rotation such that the pattern is formed when said reel unit stops rotating.

11. The gaming apparatus of claim 8, wherein, in step a), the player is able to operate said input unit repeatedly until the pattern formed by the indicia displayed in the cells of the cell matrix is found by the player to be satisfactory on the basis of the predetermined winning criteria.

12. The gaming apparatus of claim 8, wherein the gaming method further includes, prior to step a), a step (e) of:
in response to authority procurement by the player through said input unit, granting the player a right to operate said input unit further to proceed with step a) of the gaming method.

13. The gaming apparatus of claim 8, wherein the gaming method further includes, after step d), the steps of:
f-1) determining if the player wishes to operate said input unit for changing the pattern formed by the indicia displayed in the cells of the cell matrix;
f-2) if it is determined that the player wishes to operate said input unit for changing the pattern, repeating step a) to display another pattern; and
f-3) if it is determined that the player does not wish to operate said input unit for changing the pattern, permitting the player to change the bet placed thereby through said input unit before starting another game round.

14. The gaming apparatus of claim 13, wherein the gaming method further includes, after step f-3), the steps of:
g-1) determining if the player wishes to change the bet placed thereby;
g-2) if it is determined that the player wishes to change the bet placed thereby, allowing the player to change the bet placed thereby through said input unit, and proceeding to step b); and
g-3) if it is determined that the player does not wish to change the bet placed thereby, proceeding directly to step b).

15. The gaming apparatus of claim 8, wherein the predetermined winning criteria include the display of a predetermined number of the same indicium in adjacent ones of the cells of the selected one of the cell groups.

16. A computer program product comprising a computer-readable storage medium that stores a gaming program for causing an electronic gaming apparatus to execute steps of a gaming method including:
a) in response to operation of the electronic gaming apparatus by a player for initiating a game, displaying a cell matrix including a plurality of cell groups, each of the cell groups including a plurality of cells, each of the cells displaying an indicium selected automatically and randomly by the electronic gaming apparatus from a predetermined set of indicia, the indicia displayed in the cells of the cell groups of the cell matrix forming a pattern;
b) in response to abet placed by the player, randomly selecting one of the cell groups, and notifying the player of the selected one of the cell groups;
c) determining if the indicia displayed in the cells of the selected one of the cell groups comply with predetermined winning criteria; and
d) if it is determined that the indicia displayed in the cells of the selected one of the cell groups comply with the predetermined winning criteria, granting an award to the player on the basis of the bet placed by the player and the predetermined winning criteria to thereby complete a game round.

17. The computer program product of claim 16, wherein, in step a), the player is able to operate the electronic gaming apparatus repeatedly until the pattern formed by the indicia displayed in the cells of the cell matrix is found by the player to be satisfactory on the basis of the predetermined winning criteria.

18. The computer program product of claim 16, wherein the gaming method further includes, prior to step a) a step (e) of:
in response to authority procurement by the player, granting the player a right to operate the electronic gaming apparatus.

19. The computer program product of claim 16, wherein the gaming method further includes, after step d), the steps of:
f-1) determining if the player wishes to change the pattern formed by the indicia displayed in the cells of the cell matrix;
f-2) if it is determined that the player wishes to change the pattern, repeating step a) to display another pattern; and
f-3) if it is determined that the player does not wish to change the pattern, permitting the player to change the bet placed thereby before starting another game round.

20. The computer program product of claim 19, further comprising, after step f-3), the steps of:
g-1) determining if the player wishes to change the bet placed thereby;
g-2) if it is determined that the player wishes to change the bet placed thereby, allowing the player to change the bet placed thereby, and proceeding to step b); and
g-3) if it is determined that the player does not wish to change the bet placed thereby, proceeding directly to step b).

21. The computer program product of claim 16, wherein the predetermined winning criteria include the display of a predetermined number of the same indicium in adjacent ones of the cells of the selected one of the cell groups.
